(19) United States
(12) Patent Application Publication
(10) Pub. No.: US 2026/0055556 A1
(43) Pub. Date: Feb. 26, 2026

(54) Micro-Embossed Multi-Ply Tissue Product

(71) Applicant: Kimberly-Clark Worldwide, Inc., Neenah, WI (US)

(72) Inventor: Massimo Cagnone, Prato Sesia (IT)

(21) Appl. No.: 19/104,546

(22) PCT Filed: Sep. 13, 2023
(86) PCT No.: PCT/US2023/032596

§ 371 Date: Feb. 18, 2025

Related U.S. Application Data
(60) Provisional application No. 63/405,918, filed on Sep. 13, 2022.

(51) Int. Cl. D21H 27/30; B31F 1/07; D21H 27/00; D21H 27/02

(52) U.S. Cl. CPC D21H 27/30; B31F 1/07; D21H 27/002; D21H 27/02; B31F 2201/0761

(57) ABSTRACT

Disclosed are embossed and structured multi-ply tissue products having improved softness, strength, embossment clarity and/or embossment height. The embossed and structured multi-ply tissue products include at least one embossed structured and/or textured tissue ply. The unique combination of the embossment elements provide for improved embossment element clarity and definition while using at least one thick and structured basesheet.

### BACKGROUND

During the production of many nonwoven materials, the materials are subjected to an embossing process. Embossing is a process for creating a three-dimensional image or design into the sheet material. The sheet material can be embossed by feeding the sheet material into a nip formed between an embossing roller and a backing roller. The embossing roller can define a plurality of raised elements that form embossments into the sheet material. The embossments can be formed into the sheet material using pressure alone or in combination with heat.

Nonwoven materials that are typically subjected to embossing processes include various tissue products, such as paper towels, napkins, bath tissue, facial tissue, premoistened wipes, and other products. The nonwoven materials can be embossed for many different reasons. For instance, embossing can be used in order to increase the bulk of the product, to improve the liquid absorption properties of the product, to increase the softness of the product, or simply to improve the aesthetics of the product. Embossing can also be used to attach two or more plies of the nonwoven material together or to alter or improve certain tissue product properties, such as sheet bulk and perceived softness. Embossing often increases the surface area of the sheets by introducing a plurality of protuberances and thereby enhances the bulk and handfeel of the product. Examples of apparatus and methods for embossing multi-ply paper products are described, for example, in U.S. Pat. Nos. 6,733,866, 7,871,692 and 8,287,986, U.S. Publication No. 2012/0156447, and U.S. Publication Nos. 2005/0103456, 2018/0142422, all of which are incorporated by reference herein in their entireties.

However, new technologies, such as C-TAD, UCTAD, NTT, ATMOS, and the like have allowed for the production of textured and structured basesheets. Such basesheets have a larger thickness than previous basesheets due at least in part to the hot air used to dry the basesheets on the forming wire. In addition, the forming wire itself imparts a texture on the basesheets that renders the basesheets difficult, if not impossible to further emboss, as the basesheets revert to the texture formed during drying.

A textured and/or structured basesheet with one or more embossments would be useful. A textured basesheet with improved strength, softness, or a combination thereof would also be useful.

### SUMMARY

The present disclosure is generally directed to a multi-ply tissue product that includes at least a first ply and a second ply, where the first ply includes a structured basesheet having a plurality of embossments disposed thereon. Moreover, at least a portion of the embossments have a base, a tip, and a height extending from the base to the tip in a Z direction. The base has a first side and an opposed second side, a third side and opposed fourth side, where at least one angle between adjacent sides of the first, second, third, and fourth side, is from about forty-five degrees (45°) to about one hundred and thirty-five degrees (135°). In addition, at least a portion of the embossments have a height of about one and one-tenth millimeters (1.1 mm) or greater.

Furthermore, in an example aspect, at least a portion of the embossments have a rounded tip, and/or have two or more height-extending sides having an angle with the Z direction of about two degrees (2°) to about thirty degrees (30°) such that at least a portion of the embossments have a base width and a tip width, where the tip width is less than the base width. In another example aspect, at least a portion of the embossments have a ratio of the height to the base width of about 1:1.5 or greater, or about 1:2.5 or greater. In an aspect, the height of the at least a portion of the embossments is about one and a quarter millimeters (1.25 mm) or greater. Moreover, in another example aspect, at least a portion of the embossments have at least one angle between adjacent sides that is from about seventy-five degrees (75°) to about one hundred and five degrees (105°).

Additionally or alternatively, in an aspect, the tissue product has a sheet bulk from about seven cubic centimeters per gram (7 cc/g) to about eleven cubic centimeters per gram (11 cc/g), a caliper of at least about two thousand, four hundred micrometers (2400 μm) or more per twelve plies, or a combination thereof. In yet a further example aspect, the structured basesheet includes a number of embossments to yield a density of about twenty (20) embossments per centimeter squared (cm²) of structured basesheet or greater, or about twenty-five (25) embossments per centimeter squared (cm²) or greater, or about twenty-seven and a half (27.5) embossments per centimeter squared (cm²) or greater. In another example aspect, the tissue product has a TS7 softness of about fifty (50) or greater. Furthermore, in an example aspect, the tissue product has a basis weight of about eighty grams per square meter (80 gsm) or less.

In yet another example aspect, at least a portion of the embossments are truncated pyramids having a rounded tip. Further, in an example aspect, each of the embossments present on the structured basesheet have at least one angle between adjacent sides from about seventy-five degrees (75°) and about one hundred and five degrees (105°), and the height of each embossment is about one and one and fifteen-hundredths millimeter (1.15 mm) or greater.

Moreover, in an example aspect, the multi-ply tissue product further includes a third ply disposed between the first and second plies. Additionally or alternatively, the second ply includes a second basesheet having a plurality of second embossments disposed thereon, and/or the third ply includes a third basesheet having a plurality of third embossments disposed thereon. In one example aspect, the second basesheet, the third basesheet, or both the second and third basesheet are structured basesheets. In an example aspect, the structured basesheet is formed utilizing a textured forming wire.

In yet another example aspect, the first structured basesheet, second structured basesheet, third structured basesheet, or a combination thereof, have a thickness of about one hundred and fifty micrometers (150 μm) or more prior to embossment.

In one example aspect, the tissue product includes four or more plies, where the first ply is located on an exterior side of the tissue product.

Other features and aspects of the present disclosure are discussed in greater detail below.

### BRIEF DESCRIPTION OF DRAWINGS

A full and enabling disclosure of the present disclosure is set forth more particularly in the remainder of the specification, including reference to the accompanying figures, in which:

FIG. 1A is bottom up view of a portion of a structured embossed basesheet according to example aspects of the present disclosure;

FIG. 1B is a cross-sectional view of a portion of an embossed and structured multi-ply tissue product according to example aspects of the present disclosure;

FIG. 1C is an illustration of an embossment pattern according to example aspects of the present disclosure;

FIG. 1D is an illustration of an embossment pattern according to example aspects of the present disclosure;

FIG. 2A is an illustration of a portion of an embossing roll according to example aspects of the present disclosure;

FIG. 2B is a cross-sectional illustration of an embossing element of the embossing roll of FIG. 2A;

FIG. 3 is a schematic of a process useful in the manufacture of structured embossed basesheet according example aspects of the present disclosure;

FIG. 4A is a graph of caliper according to Example 1; and

FIG. 4B is a graph of TS7 according to Example 1.

Repeat use of reference characters in the present specification and drawings is intended to represent same or analogous features or elements of the invention.

### Definitions

When introducing elements of the present disclosure or the preferred embodiment(s) thereof, the articles “a”, “an”, “the” and “said” are intended to mean that there are one or more of the elements. As used herein, the terms “includes” and “including” are intended to be inclusive in a manner similar to the term “comprising.” Similarly, the term “or” is generally intended to be inclusive (i.e., “A or B” is intended to mean “A or B or both”). Approximating language, as used herein throughout the specification and claims, is applied to modify any quantitative representation that could permissibly vary without resulting in a change in the basic function to which it is related. Accordingly, a value modified by a term or terms, such as “about,” “approximately,” and “substantially,” are not to be limited to the precise value specified and when used to modify a value, indicates that the value can be raised or lowered by 10%, such as, such as 7.5%, 5%, such as 4%, such as 3%, such as 2%, such as 1%, and remain within the disclosed aspect. Moreover, the term “substantially free of” when used to describe the amount of substance in a material is not to be limited to entirely or completely free of and may correspond to a lack of any appreciable or detectable amount of the recited substance in the material. Thus, e.g., a material is “substantially free of” a substance when the amount of the substance in the material is less than the precision of an industry-accepted instrument or test for measuring the amount of the substance in the material. In certain example embodiments, a material may be “substantially free of” a substance when the amount of the substance in the material is less than 10%, less than 9%, less than 8%, less than 7%, less than 6%, less than 5%, less than 4%, less than 3%, less than 2%, less than 1%, less than 0.5%, or less than 0.1% by weight of the material

As used herein the term “tissue web” or “basesheet” which may be used interchangeably, refers to a structure comprising a plurality of fibers such as, for example, papermaking fibers and more particularly pulp fibers, including both wood and non-wood pulp fibers, and synthetic staple fibers. A non-limiting example of a basesheet is a wet-laid sheet material that includes pulp fibers.

As used herein the term “tissue product” refers to products made from basesheet and includes, bath tissues, facial tissues, paper towels, industrial wipers, foodservice wipers, napkins, medical pads, and other similar products. Tissue products may comprise one, two, three, four, or more plies (basesheet layers) according to the present disclosure.

As used herein the term “nonwoven web” generally refers to a web having a structure of individual fibers or threads which are interlaid, but not in an identifiable manner as in a knitted fabric. Examples of suitable nonwoven fabrics or webs include, but are not limited to, meltblown webs, spunbond webs, bonded carded webs, airlaid webs, coform webs, hydraulically entangled webs, and so forth

As used herein the term “layer” refers to a plurality of strata of fibers, chemical treatments, or the like, within a ply.

The term “ply” refers to a discrete product element. An individual ply may be arranged in juxtaposition to another ply. The term may refer to a plurality of web-like components such as in a multi-ply facial tissue, bath tissue, paper towel, wipe, or napkin.

As used herein, the term “basis weight” generally refers to the bone dry weight per unit area of a tissue and is generally expressed as grams per square meter (gsm). Basis weight is measured using TAPPI test method T-220.

As used herein, the term “caliper” is the representative thickness of a single sheet (caliper of tissue products comprising two or more plies is the thickness of a single sheet of tissue product comprising all plies) measured in accordance with TAPPI test method T402 using an EMVECO 200-A Microgage automated micrometer (EMVECO, Inc., Newberg, OR). The micrometer has an anvil diameter of 2.22 inches (56.4 mm) and an anvil pressure of 132 grams per square inch (per 6.45 square centimeters) (2.0 kPa).

As used herein, the term “sheet bulk” refers to the quotient of the caliper (μm) divided by the bone dry basis weight (gsm). The resulting sheet bulk is expressed in cubic centimeters per gram (cc/g). Tissue products prepared according to the present invention generally have a sheet bulk greater than about 7.0 cc/g, more preferably greater than about 8.0 cc/g and still more preferably greater than about 9.0 cc/g, such as from about 7.00 to about 11.0 cc/g, such as from about 8.00 to about 10.0 cc/g.

As used herein the term “Embossment Height” refers to the z-directional distance between the proximal end of a respective embossment (also referred to as the “base” of the embossment, which may be generally in the same plane as non-embossed portions of the respective basesheet as will be discussed in greater detail below) and the distal end (also referred to as the “tip”, of the respective embossment.

As used here the term “Embossment Base Width” refers to the width of the base of an embossment.

As used here the term “Width at 50% Height” generally refers to the average width of an embossment at the respective embossment's midpoint.

As used herein, the term “structured basesheet” or “textured basesheet”, which may be used interchangeably, refers to a basesheet formed by one or more processes that include laying fibers on a textured forming wire to form a basesheet, and then drying the basesheet while the basesheet remains on the textured forming wire. The drying can include through air drying the basesheet after the fibers forming the structured basesheet have been laid on a textured forming wire. Thus, “structured basesheets” or “textured basesheets” as used herein, contain an inherent surface pattern formed during drying on the textured forming wire corresponding to the textured forming wire used, that is distinct from the embossments discussed herein. Further, as would be clear to one having skill in the art, the “structured basesheet” or “textured basesheet” contains the surface pattern prior to embossing as discussed herein, as will be further discussed below. In addition, “structured and/or textured basesheets” as used herein, have a thickness or caliper, prior to embossing, of about 125 μm per ply or greater, such as about 130 μm per ply or greater, such as about 150 μm per ply or greater, such as bout 175 μm per ply or greater, such as about 200 μm per ply or greater such as about 225 μm per ply or greater, such as about 250 μm per ply or greater, or any ranges or values therebetween, such as up to even about 350 μm per ply or greater.

Processes for forming structured or textured basesheets include:
creped through-air-dried (CTAD), in which the web is formed using a through-air dried tissue making process and creped after final drying;
uncreped through-air-dried (UCTAD);
new tissue technology (NTT);
advanced tissue molding system (ATMOS); and the like.

As used herein, the terms “TS7” and “TS7 value” refer to an output of an EMTEC Tissue Softness Analyzer (“TSA”) (Emtec Electronic GmbH, Leipzig, Germany) as described in the Test Methods section. The units of the TS7 value are dB V2 rms, however, TS7 values are often referred to herein without reference to units.

### DETAILED DESCRIPTION

It is to be understood by one of ordinary skill in the art that the present discussion is a description of exemplary aspects only, and is not intended as limiting the broader aspects of the present disclosure.

Generally speaking, the present disclosure is directed to a textured or structured basesheet that contains a plurality of discrete and space-apart micro-embossments. Namely, the present disclosure has unexpectedly found that by forming embossments having a unique combination of properties, structured basesheets may maintain the embossed pattern, despite being relative thick and having a preexisting textured or structured surface. Namely, the embossed and textured tissue products are an improvement over prior art structured or textured tissue products, particularly in terms of embossment clarity and definition. Without being bound by any particular theory, it is believed that the improvement in embossment clarity and definition is attributable, in-part, to the unique combination of properties of the embossments discussed herein. Thus, embossed and structured basesheets discussed herein can have improved caliper without sacrificing softness and strength due at least in part to the unique embossments as will be discussed in greater detail.

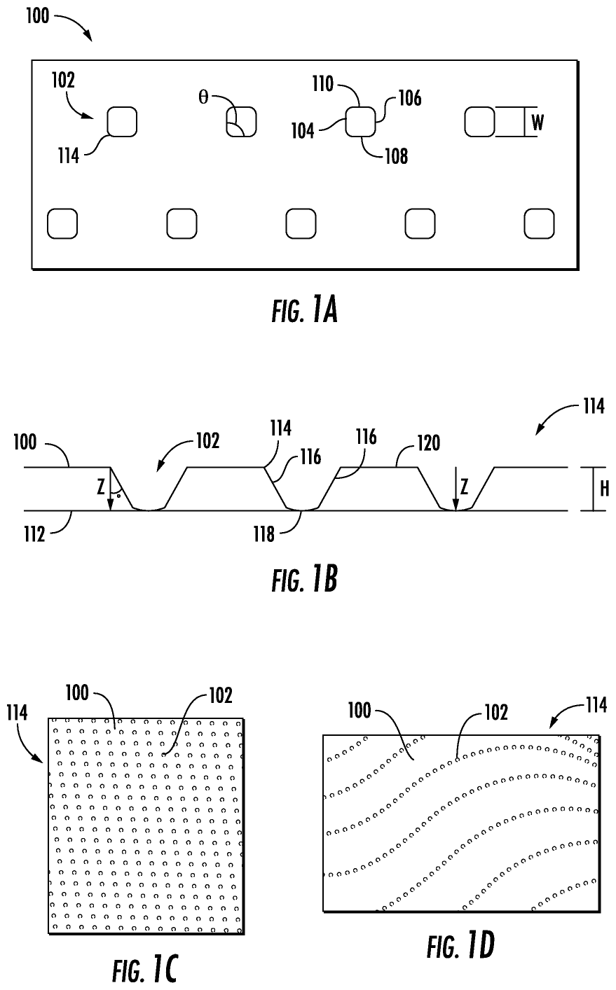

For instance, an embossed structured basesheet according to example aspects of the present disclosure includes a plurality of embossments having a quadrilateral base. The base includes a first side, a second side opposed and generally parallel to the first side, a third side, and a fourth side opposed and generally parallel to the third side. For at least a portion of the embossments, an angle between at least two adjacent sides of the base is from about 45° to about 135°, such as from about 55° to about 125°, such as from about 65° to about 115°, such as about 75° to about 105°, such as about 85° to about 95°, or any ranges or values therebetween (see, e.g. theta in FIG. 1A, which will be discussed in greater detail below). In one example aspect, the angle between at least two sets of adjacent sides can be according to the above ranges, such as about three sets, such as all fours sets of adjacent sides. Namely, without wishing to be bound by theory, it is believed that when embossments have a quadrilateral base with at least one corner having an angle according to the above ranges, due at least in part to the generally straight edges and generally square corner(s) the embossment is firmly imprinted in the basesheet and remains imprinted, even when embossed on a thick, structured or textured basesheet, thereby improving embossment clarity and definition. Thus, while in one example aspect, the base of the embossed generally defines any quadrilateral that satisfies the above angle and side restrictions, in one example aspect, the base may generally define a square.

Nonetheless, regardless of the shape of the quadrilateral base, each embossment also defines a height, which is a z-directional distance between the proximal end of a respective embossment (also referred to as the “base” of the embossment, which may be generally in the same plane as non-embossed portions of the respective basesheet as will be discussed in greater detail below) and the distal end (also referred to as the “tip”, of the respective embossment). The height, H, is shown more clearly in FIG. 1B, which will be discussed in greater detail below, where the height in the z-direction is generally perpendicular to the plane of the basesheet. Further, referring again to FIG. 2, the width of each embossment decreases from the base to the tip along the height of each embossment. Thus, each embossment may generally have a pyramidal shape, corresponding to the quadrilateral shape of the base. In such an example aspect, the Z-extending sides of the quadrilateral (e.g. the sides extending in the height direction), can have an angle to the vertical plane Z of about 5 degrees to about 35 degrees, such as about 6 degrees to about 32.5 degrees, such as about 7 degrees to about 30 degrees, such as about 8 degrees to about 27.5 degrees, such as about 9 degrees to about 25 degrees, such as about 10 degrees to about 22 degrees, or any ranges or values therebetween.

Moreover, example aspects of the present disclosure has surprisingly found that by increasing the height of the embossments to be greater than 1 mm, a balance between softness, strength, and caliper can be further improved. For instance, as noted above in regards to the shape of the corners and edges, by increasing the height of the embossment, the embossments are more firmly imprinted on the base sheet, so as to improve the definition and clarity of the embossment as well as maintain the embossments shape and size in the basesheet after formation and incorporation into a final product (e.g. maintain embossment clarity and definition even after folding and/or rolling). Such a feature is illustrated in the maintained excellent caliper. Thus, in one example aspect, the height of each embossment is about 1.1 mm or greater, such as about 1.15 mm or greater, such as about 1.2 mm or greater, such as about 1.25 mm or greater, such as about 2 mm or less, such as about 1.9 mm or less, such as about 1.8 mm or less, such as about 1.7 mm or less, such as about 1.6 mm or less, such as about 1.5 mm or less, such as about 1.4 mm or less, such as about 1.35 mm or less, or any ranges or values therebetween.

Furthermore, the increase in height may be accomplished without drastically increasing the width of the base. Therefore, a ratio of an embossments height to its base width may be greater than about 1:1, such as about 1:1.5 or greater, such as about 1:2 or greater, such as about 1:1.25 or greater, such as about 1:3 or greater, or such as about 1:10 or less, such as about 1:8 or less, such as about 1:7 or less, such as about 1:6 or less, such as about 1:5 or less, such as about 1:4 or less, or any ranges or values therebetween.

Thus, while due to the increased height, embossments according to example aspects of the present disclosure can be present in a lower density, embossments may nonetheless be present in a density of about 80 embossments per cm² or less, such as about 75 embossments per cm² or less, such as about 70 embossments per cm² or less, such as about 65 embossments per cm² or less, such as about 62.5 embossments per cm² or less, or such as about 20 embossments per cm² or greater, such as about 22.5 embossments per cm² or greater, such as about 25 embossments per cm² or greater, such as about 27.5 embossments per cm² or greater, or any ranges or values therebetween.

In one example aspect, each embossment of the present disclosure can be a truncated pyramid, in that the distal end, or tip of the pyramid has been removed. It should be clear, nonetheless, as illustrated in FIG. 1B, that the heights referenced above are in reference to the total height from base to tip, regardless of the truncation. Nonetheless, as illustrated in the figures, the present disclosure has unexpectedly found that softness can be further increased without compromising strength or caliper by utilizing a rounded, or domelike tip as compared to a flat tip. Thus, in one example aspect, the tip of one or more of the plurality of embossments can have a tip having a radius of curvature of about 0.05 mm to about 0.4 mm, such as about 0.06 mm to about 0.375 mm, such as about 0.07 mm to about 0.35 mm, such as about 0.08 mm to about 0.325 mm, such as about 0.1 mm to about 0.3 mm, such as about 0.2 mm to about 0.0275 mm, or any ranges or values therebetween.

Moreover, in one example aspect, each embossment has a height that is generally the same as any adjacent embossment. For instance, in one aspect, each embossment may have a height that is within about 10% or less of a height of any adjacent embossment, such as within about 9%, such as within about 8%, such as within about 7%, such as within about 6%, such as within about 5% of the heigh of any adjacent projection, and, in some example aspects, may be generally the same as any adjacent embossment, or any embossment located on the same basesheet.

Nonetheless, while the discussion so far has included a single basesheet (single ply), it should be clear that embossments as described herein are particularly well suited for aesthetic purposes, and/or for bonding two or more plies together to form a tissue product. Thus, in one example aspect, the present disclosure is generally directed to a tissue product having two or more plies, such as about three or more, such as about four or more, such as about five or more, such as about six or more, such as about seven or more, such as about eight or more, such as about nine or more, such as about ten or more, such as about eleven or more, such as about twelve or more plies, or any ranges or values therebetween, which can be referred to as a multi-ply embossed tissue product.

For instance, referring to FIGS. 1A and 1B, an embossed textured basesheet 100 contains a plurality of embossments 102 (it is noted that the texture and/or structure is illustrated more clearly in FIGS. 1C and 1D). Each embossment 102 includes a first side 104, a second side 106 opposed and parallel to the first side 104, a third side 108, and a fourth side 110 opposed and parallel to the third side 108. As shown in FIG. 1A, the embossments 102 have an angle, theta (O), between at least one set of adjacent sides (first side 104 and third side 108 in this example, can also be referred to as the corner between the first and third sides). However, it should be understood that the angle theta between at least two sets of adjacent sides may be according to the above ranges, or that all four sets of adjacent sides (corners) may have an angle according to the above. Nonetheless, as most clearly shown in FIG. 1A, each embossment 102 has a base width W.

Referring more particularly to FIG. 1B, the embossed textured basesheet 100 is bonded to a second basesheet (second ply) 112 via the illustrated embossments 102. While the disclosure thus far has only described one ply/basesheet having embossments, it should be clear that the second play 112, or any additional ply can include embossments as described herein, or standard dot embossments as known in the art. Thus, in one example aspect, at least one ply of a multi ply article contains embossments as discussed herein. Furthermore, as noted above, and while not illustrated in FIG. 2, it should be clear that the tissue product 114 can include more than two plies. In such an example aspect, the addition plies may be located between the embossed textured basesheet 100 and the second basesheet 112, or on an exterior side of the second basesheet 112. As would be understood by one having skill in the art, the additional plies are embossed synchronously such that each ply contains embossments in the same location, or the plies may be embossed in alternating regions. Regardless of the total number of plies, in one example aspect, at least one of the exterior plies (e.g. plies on the outer facing sides of the tissue product such as shown by basesheets 100 and 112 in FIG. 1B), are embossed as discussed herein, and, in one example aspect, both exterior plies can be embossed as discussed herein. Nonetheless, as noted above, each embossment 102 has a quadrilateral base 114, sloped sides 116 that decrease the width of each embossment 102 when extending from the base 114 to the tip 118 along the Z plane (or line as shown in FIG. 1B). as illustrated in FIG. 1B, the tip 118 has a domed or partial-circle cross section instead of a blunt tip. Further, the embossed basesheet 100 includes unembossed sections 120 disposed between adjacent embossments 102.

While FIGS. 1A and 1B only illustrate a portion of a tissue product 114 in order to show greater detail of embossments 102, FIGS. 1C and 1D illustrate a top down view of two exemplary tissue products 114 formed utilizing embossments 102 as discussed herein. As illustrated, the topmost ply is a textured and/or structured basesheet 100 having a plurality of embossments thereon. However, it should be understood that the patterns or layout of the embossments 102 are for example only, and instead, that embossments 102 may be utilized to form any pattern, including swirls, lines, images, branding, or the like, so as long as the dimensions and density are maintained as discussed herein.

Regardless of the number of plies and pattern selected, as noted above, a tissue product formed according to example aspects of the present disclosure exhibits excellent strength, softness, and caliper. For instance, a tissue product according to the present disclosure may have a caliper of about 2100 μm or more, such as about 2200 μm or more, such as about 2300 μm or more, such as about 2400 μm or more, such as about 2500 μm or more, such as about 2600 μm or more, up to about 3000 μm or less, or any ranges or valued therebetween, as measured according to the above definition for a tissue product including 12 plies wherein only one exterior ply is embossed as discussed herein.

Furthermore, a tissue product as discussed herein can have a TSA handfeel (TS7 softness) of about 50 or greater, such as about 55 or greater, such as about 60 or greater, such as about 62.5 or greater, such as about 65 or greater, such as about 67.5 or greater, such as about 70 or greater, such as about 75 or greater, up to about 100 or less, such as about 95 or less, such as about 90 or less, or any ranges or values therebetween.

The embossed and textured multi-ply tissue products of according to example aspects of the present disclosure may have a basis weight from about 20 to about 80 gsm, such as from about 30 to about 65 gsm, such as from about 42 to about 60 gsm. In certain example aspects, the multi-ply embossed tissue products can include two, three, four, or more tissue plies where the basis weight of each individual tissue ply is less than about 25 gsm, such as from about 10 to about 20 gsm, such as from about 10 to about 15 gsm.

In certain example aspects, the embossed and textured multi-ply tissue products of the present disclosure may have a geometric mean tensile (GMT) strength from about 150 to about 1,800 g/3″, such as from about 175 to about 1,500 g/3″, such as from about 200 to about 1,000 g/3″, or any values or ranges therebetween.

In yet another example aspect, the embossed and textured multi-ply tissue products of the present disclosure may have a sheet bulk greater than about 5.00 cc/g, such as about 5.5 cc/g or greater, such as about 6 cc/g or greater, such as about 6.5 cc/g or greater, such as from about 7.00 to about 11.0 cc/g, such as from about 8.00 to about 10.0 cc/g, or any ranges or values therebetween.

The foregoing embossed and textured multi-ply tissue products may be converted into rolled tissue products, such as rolled bath tissue products, comprising an embossed and textured multi-ply tissue product spirally wound about a core. Such rolled tissue products can include a plurality of connected, but perforated, embossed and textured multi-ply tissue products sheets that may be separated from adjacent sheets. Rolled tissue product may have a roll bulk greater than about 8.00 cc/g, such as from about 8.50 to about 15.0 cc/g, such as from about 9.00 to about 13.0 cc/g.

Nonetheless, as noted above, the tissue products according to example aspects of the present disclosure generally include two, three, four, or more tissue plies made by well-known wet-laid papermaking processes such as, for example, creped wet pressed, modified wet pressed, creped through-air dried (CTAD), or uncreped through-air dried (UCTAD), where at least one of the exterior plies is structured or textured as discussed above. In still other instances, the tissue plies may be manufactured by a process including using pressure, vacuum, or air flow through the wet web (or a combination of these) to conform the wet web into a shaped fabric and subsequently drying the shaped sheet using a Yankee dryer, or series of steam heated dryers, or some other mechanisms, including but not limited to tissue made using the ATMOS process developed by Voith or the NTT process developed by Metso; or fabric creped tissue, made using a process including transferring the wet web from a carrying surface (belt, fabric, felt, or roll) moving at one speed to a fabric moving at a slower speed (at least 5 percent slower) and subsequently drying the sheet. Those skilled in the art will recognize that these processes are not mutually exclusive, e.g., an uncreped TAD process may include a fabric crepe in the process.

As noted above, an embossed multi-ply tissue product may be constructed from two or more plies that are manufactured using the same or different tissue making techniques, so long as at least one ply is formed from a method so as to result in a textured and/or structured basesheet.

Example aspects of the present disclosure are also generally directed to a method for forming an embossed multi-ply tissue product as described herein. In one example aspect, referring to FIG. 2A which illustrates a portion of an embossing roll 200 includes a plurality of embossing elements 202 having the same, similar or shapes. Namely, the embossing elements 202 have sizes and dimensions sufficient to provide embossments as discussed above. Further, FIG. 2B illustrates a single embossing element in cross-section.

For instance, in one example aspect, an embossing roll according to the present disclosure includes a plurality of embossing elements 202 having a quadrilateral base 214. The base includes a first side 204, a second side 206 opposed and parallel to the first side, a third side 208, and a fourth side 210 opposed and parallel to the third side. For at least a portion of the embossing elements, an angle between at least two adjacent sides of the base is from about 45° to about 135°, such as from about 55° to about 125°, such as from about 65° to about 115°, such as about 75° to about 105°, such as about 85° to about 95°, or any ranges or values therebetween. In one example aspect, the angle between at least two sets of adjacent sides can be according to the above ranges, such as about three sets, such as all fours sets of adjacent sides. Thus, while in one example aspect, the base of an embossing element 202 defines any quadrilateral that satisfies the above angle and side restrictions, in one example aspect, the base may generally define a square.

Nonetheless, regardless of the shape of the quadrilateral base, each embossing element 202 also defines a height, Hₑ, which is a z-directional distance between the proximal end of a respective embossing element 202 (also referred to as the “base” 214 of the embossing element, and the distal end 218 (also referred to as the “tip”, of the respective embossing element). The height, Hₑ, is shown more clearly in FIG. 2B, where the height in the z-direction is generally perpendicular to the plane of the embossing roll 200. Further, referring again to FIG. 2B, the width of each embossing element 202 decreases from the base width Wₑ to the tip along the height Hₑ of each embossment element 202. Thus, each embossing element 202 may generally have a pyramidal shape (see, e.g. FIG. 1A), corresponding to the quadrilateral shape of the base 214. In such an example aspect, Z-extending sides of the embossing element 202 (e.g. the sides extending in the height direction), can have an angle to the vertical plane Z of about 5 degrees to about 35 degrees, such as about 6 degrees to about 32.5 degrees, such as about 7 degrees to about 30 degrees, such as about 8 degrees to about 27.5 degrees, such as about 9 degrees to about 25 degrees, such as about 10 degrees to about 22 degrees, or any ranges or values therebetween.

In one example aspect, the height H of each embossing element 202 is greater than 1 mm, such as about 1.1 mm or greater, such as about 1.15 mm or greater, such as about 1.2 mm or greater, such as about 1.25 mm or greater, such as about 2 mm or less, such as about 1.9 mm or less, such as about 1.8 mm or less, such as about 1.7 mm or less, such as about 1.6 mm or less, such as about 1.5 mm or less, such as about 1.4 mm or less, such as about 1.35 mm or less, or any ranges or values therebetween.

Furthermore, the increase in height may be accomplished without drastically increasing the width of the base of the embossing element 202. Therefore, a ratio of the height Hₑ of the embossing element 202 to the width Wₑ of the base 214 may be greater than about 1:1, such as about 1:1.5 or greater, such as about 1:2 or greater, such as about 1:1.25 or greater, such as about 1:3 or greater, or such as about 1:10 or less, such as about 1:8 or less, such as about 1:7 or less, such as about 1:6 or less, such as about 1:5 or less, such as about 1:4 or less, or any ranges or values therebetween.

Embossing elements 202 according to example aspects of the present disclosure can be present on the embossing roll 200 in a density of about 80 embossments per cm² or less, such as about 75 embossing elements per cm² or less, such as about 70 embossing elements per cm² or less, such as about 65 embossing elements per cm² or less, such as about 62.5 embossing elements per cm² or less, or such as about 20 embossing elements per cm² or greater, such as about 22.5 embossing elements per cm² or greater, such as about 25 embossing elements per cm² or greater, such as about 27.5 embossing elements per cm² or greater, or any ranges or values therebetween.

In one example aspect, each embossment of the present disclosure can be a truncated pyramid, in that the distal end, or tip of the pyramid has been removed. It should be clear, nonetheless, as illustrated in FIG. 2B, that the heights referenced above are in reference to the total height from base to tip, regardless of the truncation. Nonetheless, as illustrated in the Figures, the present disclosure has unexpectedly found that softness can be further increased without compromising strength or caliper by utilizing a rounded, or domelike tip as compared to a flat tip. Thus, in one example aspect, the tip of one or more of the plurality of embossment elements can have a tip having a radius of curvature of about 0.05 mm to about 0.4 mm, such as about 0.06 mm to about 0.375 mm, such as about 0.07 mm to about 0.35 mm, such as about 0.08 mm to about 0.325 mm, such as about 0.1 mm to about 0.3 mm, such as about 0.2 mm to about 0.0275 mm, or any ranges or values therebetween.

The embossing elements may be arranged and sized to provide the product with an embossed pattern having a total embossed surface area of about 1% or greater, such as about 2% or greater, such as about 3% or greater, such as about 4% or greater, such as about 5% or greater, such as about 6% or greater, such as about 30% or less, such as about 25% or less, such as about 20% or less, such as about 15% or less, such as about 12.5% or less, such as about 10% or less, or any ranges or values therebetween, based upon the total surface area of the respective basesheet.

To produce embossed and textured multi-ply tissue products, multiple base tissue sheets are prepared and then combined using well known processing machines (converting machines) which include operations such as unwinding the base tissue sheets, calendering, printing, embossing, bonding of individual plies to be combined together as well as cutting, perforation and folding. As noted above, it should be clear that at least one basesheet is a textured or structured basesheet, that is subsequently embossed. An embossing process is carried out in the nip between an embossing roll, also referred to herein as a patterned roll, and an anvil roll, also referred to herein as a counter roll. The embossing roll can have protrusions on the circumferential surface of the embossing roll leading to embossments in the paper web.

In certain example aspects, the tissue products of the present invention may be manufactured from two or more base sheet webs, such as two, three, four, or more basesheet webs that are combined together and embossed using an embossing technique commonly referred to as DESL (Double Embossing Single Lamination), which in certain instances may be arranged so as to provide a nested configuration, as described in more detail below. In the DESL process, a first web is directed through the nip between an embossing roll and an anvil roll. In this nip the web is provided with an embossing pattern. Thereafter, an application roll for adhesive applies adhesive to those parts of the first web at which there are protruding embossing elements in the embossing roll. The adhesive is transported from an adhesive bath via an adhesive transfer roll to the application roll. A second web is transported to the first web and adhesively bonded to the first web in the nip between the so-called marrying roll and the embossing roll. The adhesive bonding takes place at those portions at which the adhesive was applied.

The process further includes an additional pair of rolls consisting of a second embossing roll and a second anvil roll. The additional pair of rolls serves to emboss the second web before the second web is adhesively bonded to the first web using the marrying roll. Typically, the additional pair of rolls is placed close to the first pair of rolls and the marrying roll. Especially when using the Nested-method, such close arrangement is important. The Nested-method can be considered as a special case of the general DESL-manufacturing method. For the Nested-method, the embossing elements of the first embossing roll and the embossing elements of the second embossing roll are arranged such that the embossed elements of the first embossed ply and the embossed elements of the second embossed ply fit into each other similar to a gearing system. This serves to achieve a mutual stabilization of the two plies. However, for the DESL manufacturing method such correlation between the embossed elements of the first, upper ply, and the second, lower ply, does not have to apply.

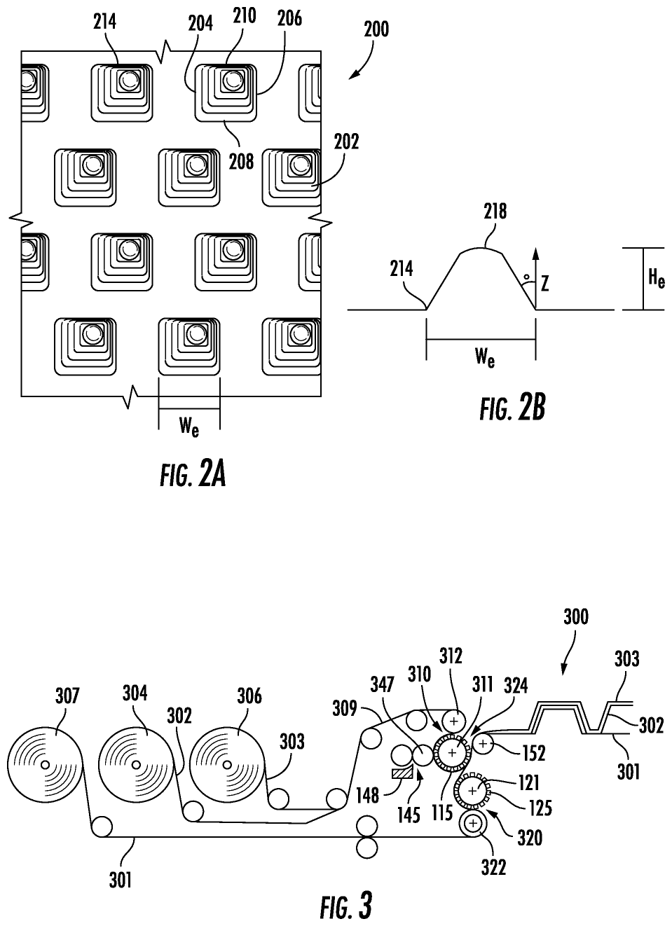

Turning now to FIG. 3, there is illustrated a method for forming an embossed and textured multi-ply tissue product according to example aspects of the present disclosure. The example of FIG. 3 illustrates three-ply tissue product 200 including first, second and third plies 301, 302, 303 with the first and second plies 302, 303 unwound from the first and second parent rolls 304, 306 and plied together prior to embossing and the third ply 301 is unwound from a third parent roll 307. However, it should be understood that further plies may be included as discussed above. In certain instances, one or plies may be optionally pre-embossed in a first pre-embossing station or be subjected to other converting steps, such as calendering or slitting.

For example, as illustrated in FIG. 3, the first and second plies 302, 303 are directed into the first nip 310 of a first embossing station that includes a first embossing roll 311 and an anvil roll 312. In the nip between the first embossing roll 311 and anvil roll 312, the first and second plies 302, 303 receive a first embossing pattern by being brought into contact with first embossing elements 315 disposed on the surface of the first embossing roll 311 (corresponding to the embossing elements 202 of embossing roll 200 as previously discussed in regards to FIGS. 2A and 2B).

In one example aspect, the embossing roll 311 is made of metal, especially steel, hard plastics materials or hard rubber. In case of plastics, very hard plastic material can be preferred, alternatively a resin material is also possible. In particular example embodiments, the anvil roll is made of rubber like EPDM or NBR (acrylonitrile-butadiene rubber), paper or steel. The rubber can have a hardness between 20 and 85 Shore A, preferably between 35 and 60 Shore A and most preferably a hardness of about 45 Shore A.

The embossing roll 311 may be made by any suitable process known in the art. Non-limiting examples of suitable processes include laser engraving hard plastic (ebonite) or ceramic or other material suitable for laser ablation to remove material and create embossing elements, chemical engraving of steel or other materials to remove material and create embossing elements, machining aluminum or steel or other metals to remove material and create embossing elements, metallizing processes to build up embossing elements, sintering processes to build up embossing elements and/or other means known in the art to remove material or build up material and achieve a surface topography with the desired pattern and clearances between mating embossing elements. In one aspect, the present disclosure has found that the embossing roll 311, may be formed completely from a chemical engraving process.

The bottom ply 301, also referred to herein as the third ply, is unwound from a third parent roll 307 and introduced into the nip 320 formed between a second embossing roll 321 and a second anvil roll 322 which form a second embossing station. As regards the possible materials for the second embossing roll 321 and a second anvil roll 322, the same materials as described above with reference to the first embossing roll 311 and the first anvil roll 312 also apply. Upon passing through the embossing nip 320 the bottom ply 301 is provided with a second embossing pattern, which is preferably different than the pattern applied by the first embossing station, but can also be the same as discussed above. The embossing pattern is imparted to the bottom ply 301 by contacting the bottom ply 301 with a plurality of second embossing elements 125 disposed on the second embossing roll 321. However, as noted above, in one example aspect, one or more of the bottom ply 301, the first ply 302, and/or second ply 303 are not embossed, such that only the first ply 302 and/or bottom ply 301 is embossed according to the present disclosure.

The process may further include an application device 145, which may include an applicator roll 147 for applying functional substances 148 to the second ply 302 after the second ply 302 exits the first embossing nip 310. Such applicator devices are well known in the art and commonly used for the application of adhesives or colored substances. For example, the process may include an applicator roll 147, which contacts the protrusions on the second ply 302 while supported by the first embossing roll 311.

In one example aspect, an adhesive is applied by the application device, which can include an adhesive applicator roll running against the first embossing roll. For laminating the single webs of material together, different types of adhesive can be used. Suitable adhesives are, inter alia, glue on the basis of starch or modified starch like, for example, methyl cellulose or carboxylated methyl cellulose, and adhesively acting polymers on the basis of synthetic resins, caoutchouc, polypropylene, polyisobutylene, polyurethane, polyacrylates, polyvinyl acetate or polyvinyl alcohol. Such adhesives can also contain coloring agents in order to improve the optical appearance of the finished products. Frequently, water-based glues are used for laminating together paper layers.

The first embossing roll 311 and the second embossing roll 321 are operated in registration with one another, which means that both rolls have to be operated in a synchronized manner such that the embossed or unembossed third ply 301 leaving the second embossing roll 321 or bypassing the second embossing roll 321 can be directed in a predetermined positional relationship onto the first and second plies 302, 303 still on the surface of the first embossing roll 311. In this way, the first, second and third plies 301, 302, 303 are combined to form an embossed and textured multi-ply tissue product according to the present disclosure.

Further, a marrying roll 152 runs against the first embossing roll 311 such that the subunit including the first and second plies 302, 303 and optionally a glue applied to a part of the surface of the second ply 102 can be brought in contact with the bottom ply 301. In this manner the bottom ply 301 is laminated to the middle ply 302 in a third nip 324 formed between the first embossing roll 311 and the marrying roll 152.

### TEST METHODS

### Sheet Bulk

Sheet Bulk is calculated as the quotient of the dry sheet caliper (μm) divided by the basis weight (gsm). Dry sheet caliper is the measurement of the thickness of a single tissue sheet measured in accordance with TAPPI test methods T402 and T411 om-89. The micrometer used for carrying out T411 om-89 is an Emveco 200-A Tissue Caliper Tester (Emveco, Inc., Newberg, OR). The micrometer has a load of 2 kilo-Pascals, a pressure foot area of 2,500 square millimeters, a pressure foot diameter of 56.42 millimeters, a dwell time of 3 seconds, and a lowering rate of 0.8 millimeters per second.

### Tensile

Tensile testing was done in accordance with TAPPI test method T-576 “Tensile properties of towel and tissue products (using constant rate of elongation)” wherein the testing is conducted on a tensile testing machine maintaining a constant rate of elongation and the width of each specimen tested is 3 inches. More specifically, samples for dry tensile strength testing were prepared by cutting a 3±0.05 inch (76.2±1.3 mm) wide strip in either the machine direction (MD) or cross-machine direction (CD) orientation using a JDC Precision Sample Cutter (Thwing-Albert Instrument Company, Philadelphia, PA, Model No. JDC 3-10, Serial No. 37333) or equivalent. The instrument used for measuring tensile strengths was an MTS Systems Sintech 11S, Serial No. 6233. The data acquisition software was an MTS TestWorks® for Windows Ver. 3.10 (MTS Systems Corp., Research Triangle Park, NC). The load cell was selected from either a 50 Newton or 100 Newton maximum, depending on the strength of the sample being tested, such that the majority of peak load values fall between 10 to 90 percent of the load cell's full scale value. The gauge length between jaws was 4±0.04 inches (101.6±1 mm) for facial tissue and towels and 2±0.02 inches (50.8±0.5 mm) for bath tissue. The crosshead speed was 10±0.4 inches/min (254±1 mm/min), and the break sensitivity was set at 65 percent. The sample was placed in the jaws of the instrument, centered both vertically and horizontally. The test was then started and ended when the specimen broke. The peak load was recorded as either the “MD tensile strength” or the “CD tensile strength” of the specimen depending on direction of the sample being tested. Ten representative specimens were tested for each product or sheet and the arithmetic average of all individual specimen tests was recorded as the appropriate MD or CD tensile strength of the product or sheet in units of grams of force per 3 inches of sample. The geometric mean tensile (GMT) strength was calculated and is expressed as grams-force per 3 inches of sample width. Tensile energy absorbed (TEA) and slope are also calculated by the tensile tester. TEA is reported in units of gm·cm/cm². Slope is recorded in units of kg. Both TEA and Slope are directionally dependent and thus MD and CD directions are measured independently. Geometric mean TEA and geometric mean slope are defined as the square root of the product of the representative MD and CD values for the given property.

### Example 1

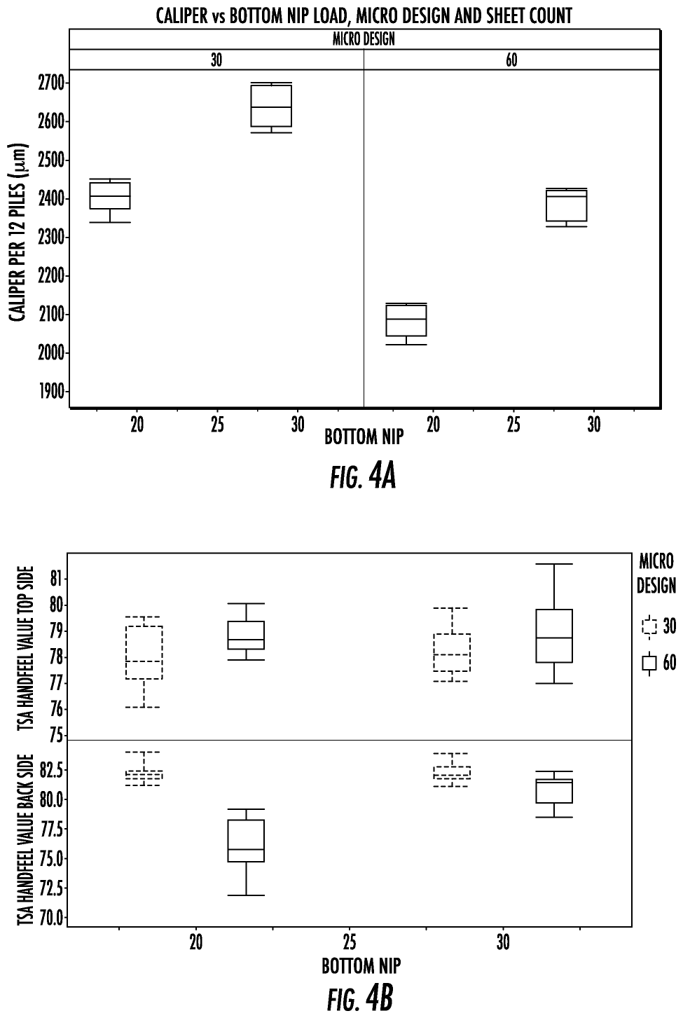

Two sets of basesheets formed via NTT having a basis weight of 22.5, caliper of 1519 μm per 12 plies, bulk of 6.1 cc/g, and TSA handfeel of 80 (prior to embossing) were embossed according to Table 1. As shown, the control set utilized existing micro embossing of 60 embossments per cm², the embossments have an oval or dot cross-sectional shape and an element height of 1 mm. Conversely, Sample 1 utilized embossments as discussed herein. Namely, Sample 1 utilized 30 embossments per cm², the embossments having a pyramidal cross-sectional shape with a rounded top (as illustrated in FIG. 2A), with an element height of 1.2 mm. The samples were tested for various properties, as shown in the graphs of FIGS. 4A and 4B.

TABLE 1

| | Control | Sample 1 |
|---|---|---|
| | (“micro 60”) | (“micro 30”) |
| Embossments per cm² | 60 | 30 |
| Element Shape | Oval/Dot | Pyramidal with |
| | | rounded top |
| Element Height | 1 mm | 1.2 mm |

As illustrated, the samples according to the present disclosure exhibited a 15 to 25% increase in caliper as compared to the control (when comparing samples at the same nip load), without sacrificing softness.

These and other modifications and variations to the present disclosure may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only and is not intended to limit the invention so further described in such appended claims.

### EXAMPLE EMBODIMENTS

First example embodiment: A multi-ply tissue product comprising: a first ply comprising a structured basesheet having a plurality of embossments disposed thereon; and a second ply, wherein at least a portion of the embossments have a base, a tip, and a height extending from the base to the tip in a Z direction, the base having a first side and an opposed second side, and a third side and opposed fourth side, wherein at least one angle between adjacent sides of the first, second, third, and fourth side is from about forty-five degrees to about one hundred and thirty-five degrees, and wherein the height of the at least a portion of the embossment is about one and one-tenth millimeters or greater.

Second example embodiment: The multi-ply tissue product of the first example embodiment, wherein at least a portion of the embossments have a rounded tip.

Third example embodiment: The multi-ply tissue product of either the first or second example embodiments, wherein at least a portion of the embossments have two or more height-extending sides having an angle with the Z direction of about two degrees to about thirty degrees such that at least a portion of the embossments have a base width and a tip width, where the tip width is less than the base width.

Fourth example embodiment: The multi-ply tissue product of any one of the first through third example embodiments, wherein at least a portion of the embossments have a ratio of the height to the base width of about 1:1.5 or greater, or about 1:2.5 or greater.

Fifth example embodiment: The multi-ply tissue product of any one of the first through fourth example embodiments, wherein the tissue product has a sheet bulk from about seven cubic centimeters per gram to about eleven cubic centimeters per gram.

Sixth example embodiment: The multi-ply tissue product of any one of the first through fifth example embodiments, wherein the tissue product has a caliper of at least about two thousand, one hundred micrometers or more per twelve plies.

Seventh example embodiment: The multi-ply tissue product of any one of the first through sixth example embodiments, wherein the height of the at least a portion of the embossments is about one and a quarter millimeters or greater.

Eighth example embodiment: The multi-ply tissue product of any one of the first through seventh example embodiments, wherein the structured basesheet includes a number of embossments to yield a density of about twenty embossments per centimeter squared of structured basesheet or greater, or about twenty-five embossments per centimeter squared or greater, or about twenty-seven and a half embossments per centimeter squared or greater.

Nineth example embodiment: The multi-ply tissue product of any one of the first through eighth example embodiments, wherein at least a portion of the embossments have at least one angle between adjacent sides from about seventy-five degrees to about one hundred and five degrees.

Tenth example embodiment: The multi-ply tissue product of any one of the first through nineth example embodiments, wherein at least a portion of the embossments are truncated pyramids having a rounded tip.

Eleventh example embodiment: The multi-ply tissue product of any one of the first through tenth example embodiments, wherein each of the embossments present on the structured basesheet have at least one angle between adjacent sides from about seventy-five degrees and about one hundred and five degrees, and wherein the height of each embossment is about one and fifteen-hundredths millimeters or greater.

Twelfth example embodiment: The multi-ply tissue product of any one of the first through eleventh example embodiments, wherein the tissue product has a TS7 softness of about fifty or greater.

Thirteenth example embodiment: The multi-ply tissue product of any one of the first through twelfth example embodiments, further comprising a third ply disposed between the first and second plies.

Fourteenth example embodiment: The multi-ply tissue product of any one of the first through thirteenth example embodiments, wherein the second ply comprises a second basesheet having a plurality of second embossments disposed thereon.

Fifteenth example embodiment: The multi-ply tissue product of any one of the first through fourteenth example embodiments, wherein the third ply comprises a third basesheet having a plurality of third embossments disposed thereon.

Sixteenth example embodiment: The multi-ply tissue product of any one of the first through fifteenth example embodiments, wherein the tissue product has a basis weight of about eighty grams per square meter or less.

Seventeenth example embodiment: The multi-ply tissue product of any one of the first through sixteenth example embodiments, wherein the structured basesheet is formed utilizing a textured forming wire.

Eighteenth example embodiment: The multi-ply tissue product of any one of the first through seventeenth example embodiments, wherein the second basesheet, the third basesheet, or both the second and third basesheet are structured basesheets.

Nineteenth example embodiment: The multi-ply tissue product of any one of the first through eighteenth example embodiments, the first structured basesheet, second structured basesheet, third structured basesheet, or a combination thereof, have a thickness of about one hundred and fifty micrometers or more prior to embossment.

Twentieth example embodiment: The multi-ply tissue product of any one of the first through nineteenth example embodiments, wherein the tissue product includes four or more plies, wherein the first ply is located on an exterior side of the tissue product.

1. A multi-ply tissue product comprising:
a first ply comprising a structured basesheet having a plurality of embossments disposed thereon; and
a second ply,
wherein at least a portion of the embossments have a base, a tip, and a height extending from the base to the tip in a Z direction, the base having a first side and an opposed second side, and a third side and opposed fourth side, wherein at least one angle between adjacent sides of the first, second, third, and fourth side is from about forty-five degrees to about one hundred and thirty-five degrees, and wherein the height of the at least a portion of the embossment is about one and one-tenth millimeters or greater.

2. The multi-ply tissue product of claim 1, wherein at least a portion of the embossments have a rounded tip.

3. The multi-ply tissue product of claim 1, wherein at least a portion of the embossments have two or more height-extending sides having an angle with the Z direction of about two degrees to about thirty degrees such that at least a portion of the embossments have a base width and a tip width, where the tip width is less than the base width.

4. The multi-ply tissue product of claim 3, wherein at least a portion of the embossments have a ratio of the height to the base width of about 1:1.5 or greater, or about 1:2.5 or greater.

5. The multi-ply tissue product of claim 1, wherein the tissue product has a sheet bulk from about seven cubic centimeters per gram to about eleven cubic centimeters per gram.

6. The multi-ply tissue product of claim 1, wherein the tissue product has a caliper of at least about two thousand, one hundred micrometers or more per twelve plies.

7. The multi-ply tissue product of claim 1, wherein the height of the at least a portion of the embossments is about one and a quarter millimeters or greater.

8. The multi-ply tissue product of claim 1, wherein the structured basesheet includes a number of embossments to yield a density of about twenty embossments per centimeter squared of structured basesheet or greater, or about twenty-five embossments per centimeter squared or greater, or about twenty-seven and a half embossments per centimeter squared or greater.

9. The multi-ply tissue product of claim 1, wherein at least a portion of the embossments have at least one angle between adjacent sides from about seventy-five degrees to about one hundred and five degrees.

10. The multi-ply tissue product of claim 1, wherein at least a portion of the embossments are truncated pyramids having a rounded tip.

11. The multi-ply tissue product of claim 1, wherein each of the embossments present on the structured basesheet have at least one angle between adjacent sides from about seventy-five degrees and about one hundred and five degrees, and wherein the height of each embossment is about one and fifteen-hundredths millimeters or greater.

12. The multi-ply tissue product of claim 1, wherein the tissue product has a TS7 softness of about fifty or greater.

13. The multi-ply tissue product of claim 1, further comprising a third ply disposed between the first and second plies.

14. The multi-ply tissue product of claim 13, wherein the second ply comprises a second basesheet having a plurality of second embossments disposed thereon.

15. The multi-ply tissue product of claim 14, wherein the third ply comprises a third basesheet having a plurality of third embossments disposed thereon.

16. The multi-ply tissue product of claim 1, wherein the tissue product has a basis weight of about eighty grams per square meter or less.

17. The multi-ply tissue product of claim 1, wherein the structured basesheet is formed utilizing a textured forming wire.

18. The multi-ply tissue product of claim 14, wherein the second basesheet, the third basesheet, or both the second and third basesheet are structured basesheets.

19. The multi-ply tissue product of claim 18, wherein the first structured basesheet, second structured basesheet, third structured basesheet, or a combination thereof, have a thickness of about one hundred and fifty micrometers or more prior to embossment.

20. The multi-ply tissue product of claim 1, wherein the tissue product includes four or more plies, wherein the first ply is located on an exterior side of the tissue product.
